(19) United States
(12) Patent Application Publication
(10) Pub. No.: US 2024/0248674 A1
(43) Pub. Date: Jul. 25, 2024

(54) DETECT AND FACILITATE REPLAY OF MUTED VIDEOCONFERENCE PARTICIPANT

(71) Applicant: INTERNATIONAL BUSINESS MACHINES CORPORATION, ARMONK, NY (US)

(72) Inventors: Kelley Anders, East New Market, MD (US); Johnny Shieh, Austin, TX (US); Jessica Murillo, Round Rock, TX (US)

(21) Appl. No.: 18/156,454

(22) Filed: Jan. 19, 2023

(51) Int. Cl. G06F 3/16; G06F 3/01; G10L 15/22; G10L 15/26; H04L 65/1089

(52) U.S. Cl. CPC G06F 3/165; G06F 3/013; G10L 15/22; G10L 15/26; H04L 65/1089; G06F 3/0482

(57) ABSTRACT

According to one embodiment, a method, computer system, and computer program product for muted participant replay is provided. The embodiment may include, in response to determining a user is muted while speaking to one or more other participants of a web conference, capturing a recording of audio received by a microphone associated with the user. The embodiment may also include presenting a notification to the user conveying the user is on mute while presenting to the one or more other participants, where the notification includes two or more prompts which require a user response. The embodiment may further include receiving the user response to each prompt. The embodiment may also include, in response to receiving user responses to unmute and play the recording, unmuting an audio feed from the user to the one or more other participants and playing the recording for the one or more other participants.

### BACKGROUND

The present invention relates generally to the field of computing, and more particularly to web conferencing.

Web conferencing, including but not limited to audio conferencing and video conferencing, may relate to any communication between two or more individuals over a network, such as the Internet, where the participating members utilize audio and/or video streams. Web conferencing allows for a dynamic interface between users in separate locations to efficiently communicate as if they were in person by allowing face-to-face interactions and the sharing of files between participating users. Popular web conferencing applications include Zoom® (Zoom and all Zoom-based trademarks and logos are trademarks or registered trademarks of Zoom Video Communications Inc. and/or its affiliates), Webex® (Webex and all Webex-based trademarks and logos are trademarks or registered trademarks of Webex Communications, Inc. and/or its affiliates), GoToMeeting® (GoToMeeting and all GoToMeeting-based trademarks and logos are trademarks or registered trademarks of Citrix Online, LLC. and/or its affiliates), and FaceTime® (Facetime and all Facetime-based trademarks and logos are trademarks or registered trademarks of Apple Inc. and/or its affiliates) among others.

### SUMMARY

According to one embodiment, a method, computer system, and computer program product for muted participant replay is provided. The embodiment may include, in response to determining a user is muted while speaking to one or more other participants of a web conference, capturing a recording of audio received by a microphone associated with the user. The embodiment may also include presenting a notification to the user conveying the user is on mute while presenting to the one or more other participants, where the notification includes two or more prompts which require a user response. The embodiment may further include receiving the user response to each prompt. The embodiment may also include, in response to receiving user responses to unmute and play the recording, unmuting an audio feed from the user to the one or more other participants and playing the recording for the one or more other participants.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIGS. 2A-2B illustrate an operational flowchart for a muted participant replay process according to at least one embodiment.

FIG. 3 depicts a muted participant replay functional block diagram according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to web conferencing. The following described exemplary embodiments provide a system, method, and program product to, among other things, facilitate remediation when a web conference participant is trying to present to the other participants but is in a muted audio state. Therefore, the present embodiment has the capacity to improve the technical field of web conferencing by identifying when a muted participant is attempting to speak to the other web conference participants and facilitate unmuting and playback of the words spoken to, and intended for, the web conference while the participant was muted.

As previously described, Web conferencing, including but not limited to audio conferencing and video conferencing, may relate to any communication between two or more individuals over a network, such as the Internet, where the participating members utilize audio and/or video streams. Web conferencing allows for a dynamic interface between users in separate locations to efficiently communicate as if they were in person by allowing face-to-face interactions and the sharing of files between participating users. Popular web conferencing applications include Zoom® (Zoom and all Zoom-based trademarks and logos are trademarks or registered trademarks of Zoom Video Communications Inc. and/or its affiliates), Webex® (Webex and all Webex-based trademarks and logos are trademarks or registered trademarks of Webex Communications, Inc. and/or its affiliates), GoToMeeting® (GoToMeeting and all GoToMeeting-based trademarks and logos are trademarks or registered trademarks of Citrix Online, LLC. and/or its affiliates), and FaceTime® (Facetime and all Facetime-based trademarks and logos are trademarks or registered trademarks of Apple Inc. and/or its affiliates) among others.

When using typical web conferencing applications, participants may mute their audio line when they are not actively speaking to avoid inadvertent noises from disrupting other participants actively conversing, presenting, or otherwise speaking. At times, a host participant may mute all participants, besides the presenting participant, to avoid distractions originating from other participants' audio feeds from occurring. However, partly due to the inconspicuous nature of mute icons on many web conferencing software graphical user interfaces, a participant may not be aware their corresponding audio feed has been muted before they begin speaking to the other participants present in the web conference and may begin speaking while muted to the other participants.

If a muted participant's video is enabled, other participants may observe the muted participant's video feed, recognize that the participant is muted, and notify the participant that they are speaking while muted so the rest of the web conference participants are unable to hear their speech. However, if video is not enabled, a muted participant may continue speaking for a longer period of time before another participant speaks up to ask if the muted participant is speaking or informing the muted participant of their muted status. Regardless of whether video is enabled or not, a participant that was speaking while muted will usually be forced to repeat any speech spoken while on mute so that the remaining web conference participants can hear what was previously said by the muted participant. This creates an issue for the now unmuted participant who is forced to not only repeat the words spoken while muted but also remember the words spoken while muted, which, depending on the length of time that the user was speaking while muted, may be difficult especially when interrupted by another participant about their muted status and then efforts to unmute themselves.

Some current web conferencing technologies display an icon indicating a web conference participant is muted, such as in a participant list sidebar and on a participant video feed window or avatar. Furthermore, some web conferencing technologies may detect, through a participant's muted microphone, that the participant is speaking and notify the user that they are muted. However, the muted participant must manually unmute their audio and repeat any speech spoken while the participant was muted since it was not broadcast to the other participants. As such, it may be advantageous to, among other things, identify when a muted participant is addressing other participants in a web conference, record the muted participant's speech while muted, and replay the recorded speech to the web conference rather than require the muted participant to repeat the speech upon becoming unmuted.

According to one embodiment, a muted participant replay program may interface with or be integrated to a web conferencing program in a manner that allows the muted participant replay program to identify statements spoken by muted participants that are intended for transmission to the other participants of a web conference. The muted participant replay program may identify speech spoken by a muted participant as being intended for transmission to the web conference through vocal analysis techniques of both the muted participant and the conversation occurring among the muted participants. Upon identifying that muted speech is intended for transmission to the entirety of the web conference, the muted participant replay program may record the speech spoken by the muted participant, notify the muted participant that they are in a muted audio state, and prompt the participant as to whether the muted participant replay program should replay a recorded statement of the speech captured while the participant was spoken and whether the muted participant should be unmuted. In one or more other embodiments, the muted participant replay program may create a speech-to-text translation of the recorded statement and display the translation on a graphical user interface associated with each web conference participant.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

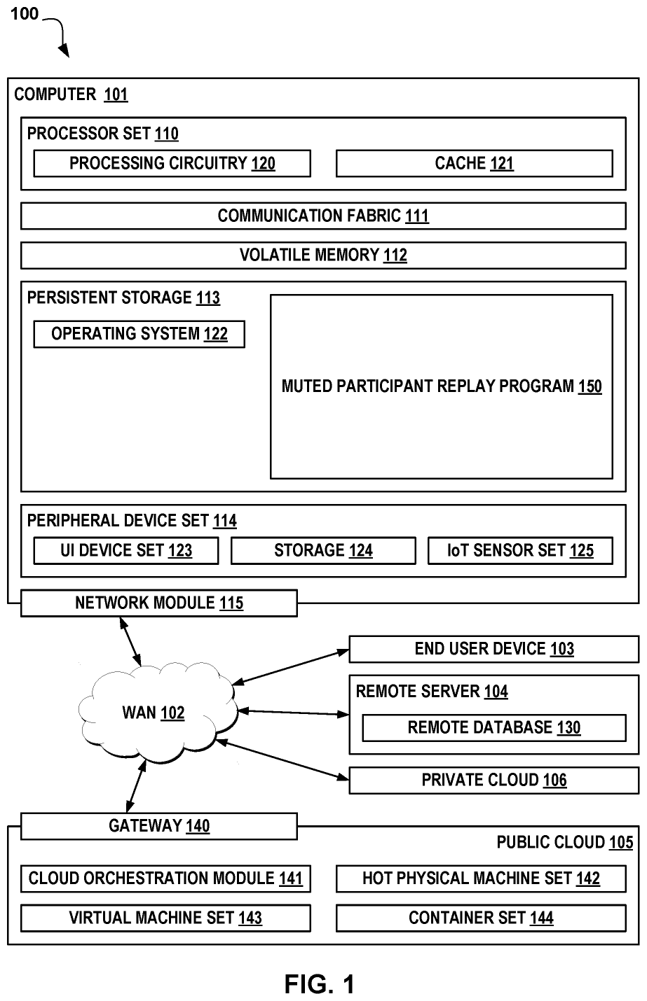

Referring now to FIG. 1, computing environment 100 contains an example of an environment for the execution of at least some of the computer code involved in performing the inventive methods, such as muted participant replay program 150. In addition to muted participant replay program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and muted participant replay program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in muted participant replay program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in muted participant replay program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the muted participant replay program 150 may include integration, or communicative coupling, with a web conferencing program to monitor participants interacting in a web conferencing using known vocal analysis techniques. Upon identifying a participant is muted and conveying speech intended for the other web conference participants, the muted participant replay program 150 may record all speech spoken by the participant that is intended for transmission to the other web conference participants.

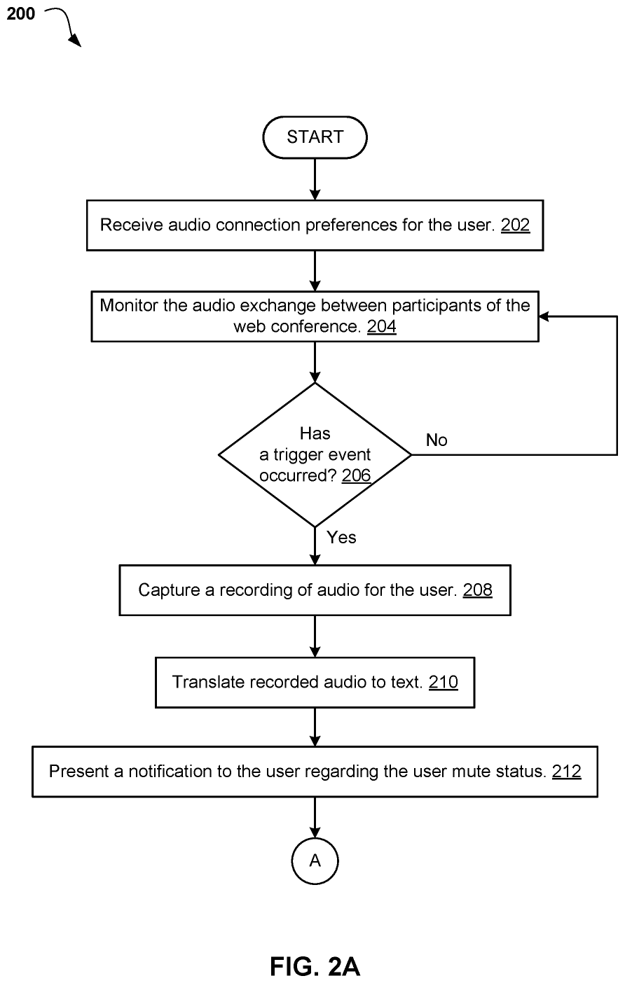

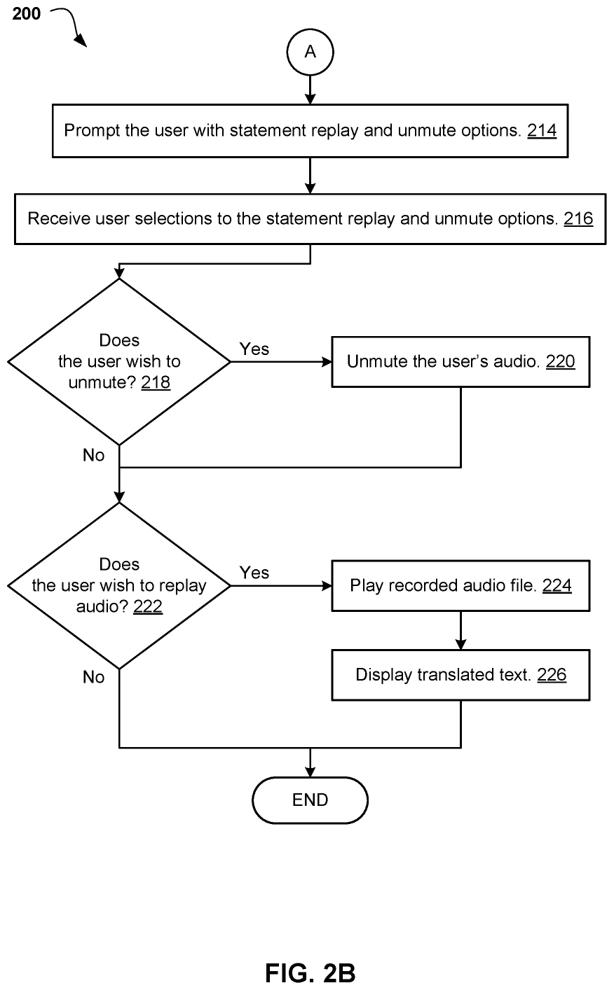

Furthermore, the muted participant replay program 150 may display a notification to the muted participant informing them of their muted status and asking if the muted participant wishes to become unmuted and playback the recorded speech to the other web conference participants. If the muted participant does not wish to become unmuted, the muted participant replay program 150 may utilize speech-to-text technology to generate a translation of the recorded audio and display the translation on a graphical user interface associated with each other web conference participant. In at least one other embodiment, the muted participant replay program 150 may save the user selections made by the web conference participant, upon user opt-in, for automatic handling of future, similar situations. Furthermore, notwithstanding depiction in computer 101, the muted participant replay program 150 may be stored in and/or executed by, individually or in any combination, end user device 103, remote server 104, public cloud 105, and private cloud 106. The muted participant replay process method is explained in more detail below with respect to FIGS. 2A and 2B.

Referring now to FIGS. 2A and 2B, an operational flowchart for a muted participant replay process 200 is depicted according to at least one embodiment. In FIG. 2A, at 202, the muted participant replay program 150 receives audio connection preferences for the user. At the commencement of a web conference, or upon entering an already commenced web conference, the muted participant replay program 150 may prompt each web conference participant to complete audio connection preferences through user interactions with a graphical user interface. The user selections may be entered using a peripheral device to computer 101, such as, but not limited to, the devices included in UI devices set 123. The audio connection preferences may include selecting hardware for audio capture, such as using the participant's computer microphone and speaker, either internal or external, or a mobile device to capture and receive audio. The muted participant replay program 150 may utilize the participant's audio connection preferences when identifying an input method for voice analysis and speech-to-text translation technologies.

In at least one embodiment, the muted participant replay program 150 may require an opt-in procedure for each web conference participant to utilize the features of the muted participant replay program 150. The opt-in procedure may indicate the types and amount of information that the muted participant replay program 150 may collect and use and the manner in which that information may be used.

Next, at 204, the muted participant replay program 150 monitors the audio exchange between the web conference participants. The muted participant replay program 150 may then monitor the exchange between web conference participants, using voice recognition technology, to determine when a trigger has taken place. For example, the muted participant replay program 150 may utilize voice recognition, speech-to-text, and natural language understanding to analyze participant conversations taking place during the web conference.

Next, at 206, the muted participant replay program 150 determines whether a trigger event has occurred. As mentioned in step 204, the muted participant replay program 150 may monitor the conversation taking place between participants of the web conference for the occurrence of a trigger event. The trigger event may include a participant speaking with language intended for transmission to the web conference however the speaking participant is muted. For example, a host user may introduce another participant, who is currently muted, and the muted participant begins to speak. The muted participant replay program 150 may determine the trigger event has occurred. Similar to monitoring the audio exchange in step 204, the muted participant replay program 150 may determine speech from participants is intended for transmission to the web conference based on vocal recognition and analysis. For example, if a participant thanks another participant, or in any way addresses another participant, the muted participant replay program 150 may determine that speech was intended for transmission to the web conference. Conversely, the muted participant replay program 150 may determine speech directed to an off-screen individual, as determined through various audio analysis tools, such as acoustical analysis and speech recognition, is not intended for transmission to the web conference.

In at least one embodiment, the muted participant replay program 150 may also utilize image and/or video analysis. In situations where the user opts-in to allowing capture of the user's camera feed in step 202, the muted participant replay program 150 may analyze the user's focus or gaze when emitting speech during a web conference. For example, if the user is focused on their laptop screen when speaking, the muted participant replay program 150 may determine that speech is intended for transmission to the web conference. However, if a user is focused off screen or off camera, the muted participant replay program 150 may determine that speech is not intended for the web conference.

Once the muted participant replay program 150 determines speech from the muted participant is not intended for the web conference, the muted participant replay program 150 may delete the segment of audio. This may be performed in an ongoing loop that records the previous preconfigured time period of user speech but deletes any recording outside of that time period. For example, the muted participant replay program 150 may be preconfigured to record the current audio and save it for ten seconds, or any preconfigured period of time sufficient for audio analysis to determine whether the emitted speech is intended for the web conference. If the muted participant replay program 150 determines that the intended speech is not intended for the web conference, the muted participant replay program 150 may delete the recorded segment.

If the muted participant replay program 150 determines the trigger event has occurred (step 206, “Yes” branch), then the muted participant replay process 200 may proceed to step 208 to capture a recording of audio for the user. If the muted participant replay program 150 determines the trigger event has not occurred (step 206, “No” branch), then the muted participant replay process 200 may return to step 204 to monitor the audio exchange between the web conference participants.

Then, at 208, the muted participant replay program 150 captures a recording of audio for the user. If the muted participant replay program 150 determines a trigger event has occurred, such as a user emitting speech intended for other participants of the web conference when their audio is muted, then the muted participant replay program 150 may begin recording the user's audio. Since the muted participant replay program 150 may determine the trigger event of a muted participant speaking to the web conference after a period of time (e.g., a few seconds) has elapsed, the muted participant replay program 150 may maintain a running recording of the user's audio feed. The muted participant replay program 150 may store the recording in a repository either in local storage, such as in storage 124, or remotely, such as in remote database 130 or on private cloud 106.

Next, at 210, the muted participant replay program 150 translates the recorded audio to text. In an ongoing basis while capturing the recording, the muted participant replay program 150 may translate the recording into written text through known speech-to-text software. Similar to the storing of the recording, the muted participant replay program 150 may store the translation in a repository either in local storage, such as in storage 124, or remotely, such as in remote database 130 or on private cloud 106.

Then, at 212, the muted participant replay program 150 presents a notification to the user regarding the user's muted status. Concurrently to beginning the recording, the muted participant replay program 150 may display a notification on a user device graphical interface indicating that the user is speaking while on mute. The notification may be presented in any number of ways including, but not limited to, a pop-up window, an icon transposed to the user's video feed or avatar on the web conferencing application, or an operating system push notification.

Referring now to FIG. 2B, at 214, the muted participant replay program 150 prompts the user with statement replay and unmute options. In the displayed notification, the muted participant replay program 150 may prompt the user with various selections as to how the user wishes to proceed including, but not limited to, selections for whether the user wishes to replay a recording of the statement they made while muted, displaying a speech-to-text translation of the recorded statement, and whether the user wishes to become unmuted. For example, the muted participant replay program 150 may display a dialog prompt of “You are currently muted. Do you wish to unmute? Do you wish to replay the statement you made while on mute?” where each question prompt is followed by an interactive element, such as a radio button or one or more selectable icons (e.g., “Yes” button and “No” button). However, the user may make their selections in any number of interactions with the graphical user interface of the device display screen through one or more peripheral devices from UI device set 123.

Next, at 216, the muted participant replay program 150 receives user selections to the statement replay and unmute options. The muted participant replay program 150 may then receive the responses to each prompt from step 214 and process through steps 218 and 220 accordingly to produce a result desired by the user. In one or more embodiments, the muted participant replay program 150 may store the received user selection in a repository, such as storage 124, remote database 130, and/or private cloud 106. Storage of the user selections may allow the muted participant replay program 150 to train a model for how the muted participant replay program 150 should handle similar, future muted speech occurrences in the current or successive web conferences. In one or more embodiments, the muted participant replay program 150 may also store the contextual situation in which the selections were made, such as, but not limited to, each web conference participant's name, job role, relationship to the user, time of day, and date.

Then, at 218, the muted participant replay program 150 determines whether the user wishes to unmute. Based on the user selections received in step 216, the muted participant replay program 150 may determine whether the user wishes to unmute their audio, which would allow the user to commence transmitting audio to the other web conference participants. If the muted participant replay program 150 determines the user wishes to unmute (step 218, “Yes” branch), then the muted participant replay process 200 may proceed to step 220 to unmute the user's audio. If the muted participant replay program 150 determines the user does not wish to unmute (step 218, “No” branch), then the muted participant replay program 150 may keep the user's audio muted and the muted participant replay process 200 may continue to step 222 to determine whether the user wishes to replay the recorded audio.

Then, at 220, the muted participant replay program 150 unmutes the user's audio. If the muted participant replay program 150 determines that the user wishes to unmute in step 218, then the muted participant replay program 150 may disengage any mute configurations previously active in the web conferencing program. In embodiments where the user is utilizing a hardware or peripheral device that has manual muting capabilities, such as a headset with a pivoting microphone that mute's audio when in the “up” position, the muted participant replay program 150 may notify the user that it is not possible to unmute audio due to the settings of the hardware or peripheral device and instruct the user to manually unmute. For example, the muted participant replay program 150 may determine that the user is using a headset with a microphone in a muted, “up” positions. Therefore, the muted participant replay program 150 may instruct the user that, to unmute, the user must move the microphone arm in the unmuted, “down” position.

In at least one other embodiment, the muted participant replay program 150 may override configurations of hardware or peripheral devices with muting capabilities and unmute the user's audio. For example, if a headset has a microphone arm in the muted, “up” position, then the muted participant replay program 150 may unmute the user's audio even while the microphone arm remains in the muted, “up” position. In one or more embodiments, the muted participant replay program 150 may indicate that hardware and/or peripheral devices are in a muted setting that has been overridden due to user selections and indicate that the user should manually align the physical setting of the hardware and/or peripheral devices to match the unmuted status to avoid any software errors.

Next, at 222, the muted participant replay program 150 determines whether the user wishes to replay audio spoken while muted. Based on the user selections received in step 216, the muted participant replay program 150 may determine whether the user wishes to replay audio recorded by the muted participant replay program 150 while the user was muted. If the muted participant replay program 150 determines the user wishes to replay recorded audio (step 222, “Yes” branch), then the muted participant replay process 200 may proceed to step 224 to play the recorded audio file. If the muted participant replay program 150 determines the user does not wish to replay the recorded audio (step 222, “No” branch), then the muted participant replay program 150 may delete the recorded audio file and the translated text from storage and the muted participant replay process 200 may end.

Then, at 224, the muted participant replay program 150 plays the recorded audio file. If the muted participant replay program 150 determines that the user wishes to replay the recorded audio in step 218, then the muted participant replay program 150 may replay the recorded audio through an audio playback program that may be embedded, through code, in the web conferencing application or connected to the web conferencing application, such as through an application programming interface (API). The muted participant replay program 150 may playback the recorded audio through a transmission to each other web conference participant so that each participant hears the recorded audio as if it were the muted participant. For example, if the muted user selects to have audio playback occur, the muted participant replay program 150 may transmit the recorded audio of the participant's spoken words, as captured by the muted participant replay program 150, while the participant was muted to each other participant of the web conference thereby allowing each participant to hear the previously muted speech. In at least one embodiment, the muted participant replay program 150 may playback the recorded speech to the participant who spoke the muted speech as if another participant were speaking. For example, the muted participant replay program 150 may transmit and play the recorded audio for all participants, including the participant who spoken the words while muted, which allows all participants to hear the muted speech. This playback type may allow the participant who spoke while muted to reevaluate what was spoken and gather thoughts due to possibly be interrupted by the notification provided by the muted participant replay program 150 in step 214 and the requirement to provide user selections in step 216.

Next, at 226, the muted participant replay program 150 displays translated text of the recorded audio. In one or more embodiments, in addition to utilizing playback of the recorded audio, the muted participant replay program 150 may also display, on a graphical user interface, the translated text from step 210. The muted participant replay program 150 may display the translated text in one text entry on the graphical user interface of the web conferencing application. In one or more embodiments, the muted participant replay program 150 may display the text entry on the video feed, avatar, or other icon of the user who spoke the muted speech. In at least one other embodiment, the muted participant replay program 150 may display the text in segments as the audio playback progresses through the recorded audio file similar to closed captioning. For example, if the muted user was beginning a presentation and introducing himself, the muted participant replay program 150 may display the first word segment “Thank you for that kind introduction” then, after deleting or, alternatively, moving to a juxtaposed position, display the second word segment “I'm really excited to be meeting with you today”.

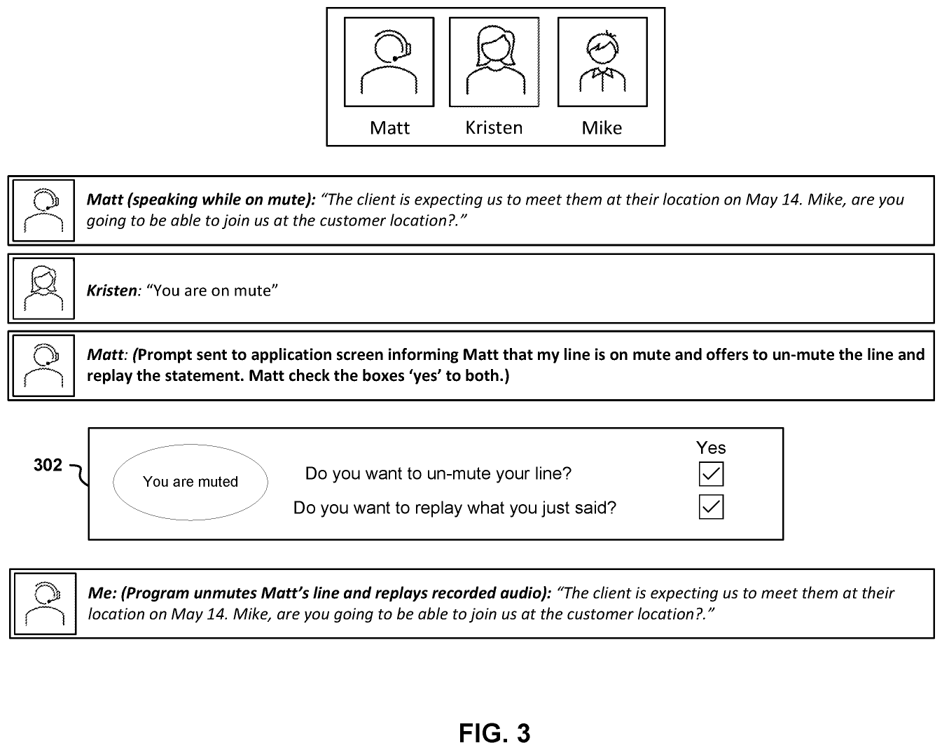

Referring now to FIG. 3, a muted participant replay functional block diagram 300 is depicted according to at least one embodiment. Three participants (i.e., Matt, Kristen, and Mike) may be conversing in a web conference when one participant (i.e., Matt) begins speaking to the group unaware that he is on mute. The muted participant replay program 150 may identify that the speaking participant is on mute through vocal analysis that the speech is intended for other individuals in the web conference or through the use of a trigger word or phrase by another web conference participant (i.e., Kristen's use of “You are on mute”). Once the muted participant replay program 150 determines the participant is muted a dialog box, such as dialog box 302, may be displayed indicating to the speaking participant that they are on mute and responses to one or more inquiries (i.e., “Do you want to un-mute your line?” and “Do you want to replay what you just said?”) may be requested. Based on the user responses, the muted participant replay program 150 may perform actions accordingly. For example, Matt may indicate that he does want to come off mute and that he does want his speech replayed for the other web conference participants. In response to these selections, the muted participant replay program 150 may unmute Matt's line and transmit the recorded speech, and in one or more embodiments the speech-to-text translation, to each other web conference participant (i.e., Kristen and Mike).

It may be appreciated that FIGS. 2A, 2B, and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
in response to determining a user is muted while speaking to one or more other participants of a web conference, capturing a recording of audio received by a microphone associated with the user;
presenting a notification to the user conveying the user is on mute while presenting to the one or more other participants, wherein the notification includes two or more prompts which require a user response;
receiving the user response to each prompt; and
in response to receiving user responses to unmute and play the recording, unmuting an audio feed from the user to the one or more other participants and playing the recording for the one or more other participants.

2. The method of claim 1, wherein the two or more prompts comprise requesting whether the user wishes to unmute and whether the user wishes for playback of the recording.

3. The method of claim 2, wherein the two or more prompts further comprise whether to display a speech-to-text translation of the recording to the one or more other participants.

4. The method of claim 3, further comprising:
performing a translation of the recording to text using a speech-to-text technology; and
in response to receiving a user response within the user responses to display the speech-to-text translation of the recording, displaying the translation on a device display screen associated with each of the one or more other participants and the user.

5. The method of claim 1, wherein capturing the recording is further performed only in response to also determining a user gaze is focused on a graphical user interface of a web conferencing software.

6. The method of claim 1, wherein capturing the recording is further performed only in response to also determining speech, emitted by the user, is intended for the one or more other participants.

7. The method of claim 1, wherein playing the recording to the one or more other participants further comprises concurrently playing the recording to the user.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
in response to determining a user is muted while speaking to one or more other participants of a web conference, capturing a recording of audio received by a microphone associated with the user;
presenting a notification to the user conveying the user is on mute while presenting to the one or more other participants, wherein the notification includes two or more prompts which require a user response;
receiving the user response to each prompt; and
in response to receiving user responses to unmute and play the recording, unmuting an audio feed from the user to the one or more other participants and playing the recording for the one or more other participants.

9. The computer system of claim 8, wherein the two or more prompts comprise requesting whether the user wishes to unmute and whether the user wishes for playback of the recording.

10. The computer system of claim 9, wherein the two or more prompts further comprise whether to display a speech-to-text translation of the recording to the one or more other participants.

11. The computer system of claim 10, further comprising:
performing a translation of the recording to text using a speech-to-text technology; and
in response to receiving a user response within the user responses to display the speech-to-text translation of the recording, displaying the translation on a device display screen associated with each of the one or more other participants and the user.

12. The computer system of claim 8, wherein capturing the recording is further performed only in response to also determining a user gaze is focused on a graphical user interface of a web conferencing software.

13. The computer system of claim 8, wherein capturing the recording is further performed only in response to also determining speech, emitted by the user, is intended for the one or more other participants.

14. The computer system of claim 8, wherein playing the recording to the one or more other participants further comprises concurrently playing the recording to the user.

15. A computer program product, the computer program product comprising:
one or more computer-readable tangible storage medium and program instructions stored on at least one of the one or more tangible storage medium, the program instructions executable by a processor capable of performing a method, the method comprising:
in response to determining a user is muted while speaking to one or more other participants of a web conference, capturing a recording of audio received by a microphone associated with the user;
presenting a notification to the user conveying the user is on mute while presenting to the one or more other participants, wherein the notification includes two or more prompts which require a user response;
receiving the user response to each prompt; and
in response to receiving user responses to unmute and play the recording, unmuting an audio feed from the user to the one or more other participants and playing the recording for the one or more other participants.

16. The computer program product of claim 15, wherein the two or more prompts comprise requesting whether the user wishes to unmute and whether the user wishes for playback of the recording.

17. The computer program product of claim 16, wherein the two or more prompts further comprise whether to display a speech-to-text translation of the recording to the one or more other participants.

18. The computer program product of claim 17, further comprising:
performing a translation of the recording to text using a speech-to-text technology; and
in response to receiving a user response within the user responses to display the speech-to-text translation of the recording, displaying the translation on a device display screen associated with each of the one or more other participants and the user.

19. The computer program product of claim 15, wherein capturing the recording is further performed only in response to also determining a user gaze is focused on a graphical user interface of a web conferencing software.

20. The computer program product of claim 15, wherein capturing the recording is further performed only in response to also determining speech, emitted by the user, is intended for the one or more other participants.
